(19) United States
(12) Patent Application Publication
(10) Pub. No.: US 2009/0102410 A1
(43) Pub. Date: Apr. 23, 2009

(54) MACHINE TOOL, PRODUCTION MACHINE AND/OR ROBOT

(75) Inventor: JOCHEN BRETSCHNEIDER, Esslingen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/253,593

(22) Filed: Oct. 17, 2008

(30) Foreign Application Priority Data
Oct. 19, 2007 (EP) EP07020514

(51) Int. Cl. G05B 13/02

(52) U.S. Cl. 318/561; 901/2

(57) ABSTRACT

A machine tool, production machine or robot includes an electric motor with a memory, and a device for open-loop and/or closed-loop control of the electric motor. The device can determine operating data of the motor, transfer the operating data to the memory, and store the operating data in the memory. The operating data of the motor can hereby be reliably determined and stored on or in the motor memory without the need to arrange a recording device, such as an operating time meter, on the motor itself. The stored data can be evaluated for determining causes of a motor malfunction.

### CROSS-REFERENCES TO RELATED APPLICATIONS

This application claims the priority of European Patent Application, Serial No. 07020514, filed Oct. 19, 2007, pursuant to 35 U.S.C. 119(a)-(d), the content of which is incorporated herein by reference in its entirety as if fully set forth herein.

### BACKGROUND OF THE INVENTION

The present invention relates to a machine tool, production machine and/or robot having a device for open-loop and/or closed-loop control of an electric motor of the machine tool, production machine and/or the robot. The present invention also relates to a method for saving operating data from an electric motor of a machine tool, production machine and/or a robot.

Nothing in the following discussion of the state of the art is to be construed as an admission of prior art.

Machine tools, production machines and/or robots normally have a plurality of motors, which are used to drive loads and especially machine elements. If such a motor fails during operation, the motor is removed and sent to the motor manufacturer for repair. It would be extremely advantageous to the motor manufacturer for rapid fault analysis and rapid fault repair if he were to know the stresses to which the motor was subjected when the motor was running.

It would therefore be desirable and advantageous to provide an improved machine tool, production machine and/or robot to obviate prior art shortcomings and to allow reliable determination of operating data of a motor of the machine tool, production machine and/or the robot and storage at the motor without the need to arrange on the motor itself a recording device, such as an operating time meter, for this purpose.

### SUMMARY OF THE INVENTION

According to one aspect of the present invention, a machine tool, production machine or robot includes an electric motor with a memory, and a device for open-loop control and/or closed-loop control of the electric motor, wherein the device is configured to determine operating data of the motor, transfer the operating data to the memory, and store the operating data in the memory.

According to another aspect of the present invention, a method for storing operating data from an electric motor of a machine tool, production machine or robot includes the steps of determining the operating data of the motor with a device which provides open-loop and/or closed-loop control of the motor, transferring the operating data from the device to a memory, and storing the transferred operating data in the memory.

Advantageously, only minor changes are required on the motor when integrating a memory in the motor, thereby obviating the need for additional costly recording devices, on the motor, such as an operating time meter.

According to another advantageous feature of the present invention, the motor operating data may include data about the operating hours of the motor, the number of revolutions of the motor during the operating hours, the motor speed at which the motor was operated, the torque supplied by the motor during the operating hours, the acceleration of the motor during operation and/or stress data derived therefrom. The stress to which the motor was subjected are primarily reflected in the aforementioned motor operating data.

According to another advantageous feature of the present invention, the device may transfer the operating data to the memory at regular intervals. This measure ensures that the motor operating data stored in the memory of the motor are updated at regular intervals and hence contain the latest values of motor operating data.

### BRIEF DESCRIPTION OF THE DRAWING

Other features and advantages of the present invention will be more readily apparent upon reading the following description of currently preferred exemplified embodiments of the invention with reference to the accompanying drawing, in which the sole FIGURE shows a machine tool, production machine and/or a robot according to the present invention:

### DETAILED DESCRIPTION OF PREFERRED EMBODIMENTS

The depicted embodiment is to be understood as illustrative of the invention and not as limiting in any way. It should also be understood that the FIGURE is not necessarily to scale and that the embodiment is sometimes illustrated by graphic symbols, phantom lines, diagrammatic representations and fragmentary views. In certain instances, details which are not necessary for an understanding of the present invention or which render other details difficult to perceive may have been omitted.

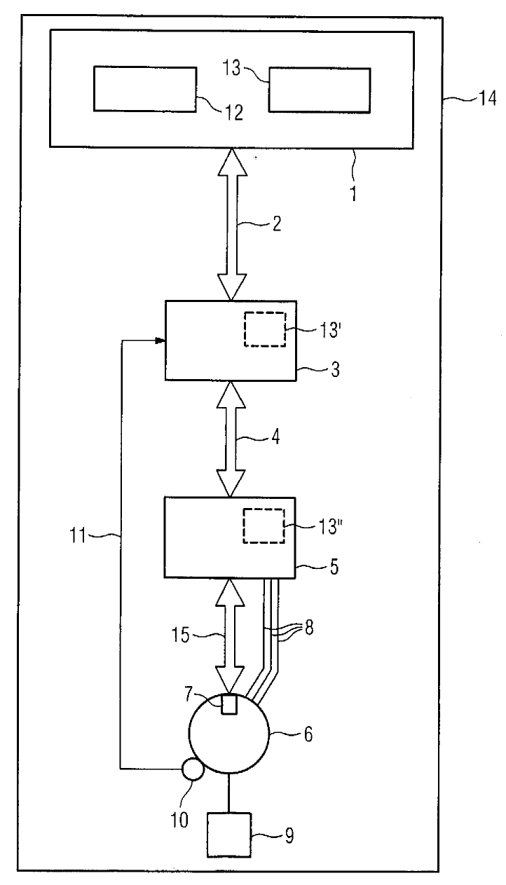

Turning now to the drawing, and in particular to FIG. 1, there is shown a block diagram of a machine 14, which can be designed as a machine tool, production machine and/or as a robot. The machine 14 has a device for open-loop and/or closed-loop control of an electric motor 6 of the machine 14, where in this exemplary embodiment the device for open-loop and/or closed-loop control is in the form of an open-loop controller 1, which essentially implements open-loop control functions. The open-loop controller 1 may here be in the form of e.g. an NC controller (Numerical Control). The open-loop controller 1 has a setpoint-value determining unit 12, which determines the setpoint values for the position and transfers them via a connection 2 to a closed-loop controller 3 as closed-loop control setpoint values for closed-loop control of an electric motor 6. The position of the rotor of the motor 6 is measured by an encoder 10 and transferred to the closed-loop controller 3 as closed-loop control actual values, which is indicated in the FIGURE by an arrow 11. The closed-loop controller 3 outputs via a connection 4 setpoint values for the current to a power converter 5, which drives and supplies electrical power to a motor 6 via electrical lines 8, according to the setpoint values for the current. The motor 6 has a memory 7 for storing data, where the memory 7 can be arranged on the motor case, for example. The power converter 5 is connected to the motor 6 via a connection 15 for transferring data to the memory 7. The motor 6 drives a load 9, which may be embodied as a feed unit or a tool spindle for example.

The closed-loop controller 3, the power converter 5 and the motor 6 form a drive of the machine 14, where the machine 14 usually has a plurality of such drives, to which the setpoint-value determining unit 12 transfers setpoint values assigned to the respective drive. For the sake of clarity, only one drive is shown in the FIGURE.

According to the invention, the open-loop controller 1 has a motor operating-data determining unit 13 for determining motor operating data of the motor 6 and, where applicable, if other motors are present in the machine 14, of these motors also. This motor operating data is understood to mean data that can be used to infer the stress of the motor 6 that occurred during operation of the motor 6. Hence the motor operating data that can be determined by the motor operating-data determining unit 13 are, for example, the hours run by the motor and/or the number of revolutions of the motor during the operating period and/or the speeds of the motor at which the motor was operated and/or the torques of the motor that occurred during operation of the motor and/or the accelerations of the motor that occurred during operation of the motor and/or the motor currents that occurred during operation of the motor.

The open-loop and closed-loop control variables occurring during operation of the motor 6, such as the closed-loop control setpoint values, closed-loop control actual values, setpoint values for the current and/or measured motor currents, are used, for example, by the motor operating-data determining unit 13, for example, to determine the motor operating data. To do this, the relevant values are transferred, for example, from the setpoint-value determining unit 12 to the motor operating-data determining unit 13, and from the closed-loop controller 3 and the power converter 5 via the connections 2 and 4 to the motor operating-data determining unit 13. The motor operating-data determining unit 13 then determines, for example, the torque M of the motor 6 from the motor setpoint current iₛₒₗₗ (motor setpoint values) set by the closed-loop controller 3 for the power converter 5, using the equation

$$M = \frac{{i}_{soll}}{k} . \qquad ( 1 )$$

k: constant (depends on given motor, gears).

The acceleration of the motor can be calculated, for example, by differentiating twice with respect to time the setpoint values for the position determined by the setpoint-value determining unit 12.

The motor operating data may exist, however, for example alternatively or additionally also in the form of stress data that is determined from the aforementioned variables. For example, the stress data can exist in the form of average values, maximum values and/or values occurring frequently over a longer operating time period (representative values) of the speeds and/or torques and/or accelerations at which the motor was operated. The motor operating data is here preferably stored together with a relevant time base so that it is possible later to trace when the stresses occurred.

The motor operating data determined in this way is preferably transferred from the open-loop controller 1 via the connections 2, 4 and 15 to the memory 7 and stored in the memory 7 at regular intervals.

A measuring unit, such as a separate operating time meter for the motor operating data, which is arranged on the motor 6, can hence be dispensed with. Thus for the invention, only minimal changes need to be made to the motor 6, such as arranging a memory 7 on the motor case.

The motor operating-data determining unit 13 need not necessarily be integrated in the open-loop controller 1 as in the exemplary embodiment, but can also be integrated in the closed-loop controller 3 or in the power converter 5, which is represented in the FIGURE by dashed lines denoted by the reference numbers 13′ and 13″. It should be mentioned at this point that the open-loop controller 1 and the closed-loop controller 3 may also form a physical entity. The closed-loop controller 3 represents an example of a device for closed-loop control of an electric motor, with essentially closed-loop control functions running in the closed-loop controller 3, where the power converter 5 can also be integrated in the closed-loop controller.

The combination of open-loop controller 1 and closed-loop controller 3, and the combination of open-loop controller 1, closed-loop controller 3 and power converter 5, each represent an example of a device for open-loop and closed-loop control of an electric motor, where a different converter can also be used instead of the power converter. The motor operating data stored in the memory 7 can be read out using an interface arranged on the motor case.

It should be pointed out here that the setpoint-value determining unit and the motor operating-data determining unit are normally implemented in the form of software.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A power-operated machine, comprising:
an electric motor having a memory, and
a device for control of the electric motor, said device configured to determine operating data of the motor, transfer the operating data to the memory, and store the operating data in the memory.

2. The machine of claim 1, wherein the operating data comprise data selected from the group consisting of operating hours of the motor, number of revolutions of the motor during the operating hours, motor speed during the operating hours, motor torque during the operating hours, motor acceleration during the operating hours, and stress data derived therefrom.

3. The machine of claim 1, wherein the device transfers the operating data to the memory at regular intervals.

4. The machine of claim 1, constructed as a machine tool.

5. The machine of claim 1, constructed as a production machine.

6. The machine of claim 1, constructed as a robot.

7. The machine of claim 1, wherein the device is constructed for an open-loop control of the electric motor.

8. The machine of claim 1, wherein the device is constructed for a closed-loop control of the electric motor.

9. A method for storing operating data from an electric motor of a machine tool, production machine or robot, said method comprising the steps of:
determining the operating data of the motor with a device providing open-loop control or closed-loop control, or both, of the motor,
transferring the operating data from the device to a memory, and
storing the transferred operating data in the memory.
